(19) United States
(12) Patent Application Publication
(10) Pub. No.: US 2017/0004493 A1
(43) Pub. Date: Jan. 5, 2017

(54) ALTERNATE PAYMENT METHOD

(71) Applicant: MUKESH KUMAR, OMAHA, NE (US)

(72) Inventor: MUKESH KUMAR, OMAHA, NE (US)

(21) Appl. No.: 15/202,073

(22) Filed: Jul. 5, 2016

Related U.S. Application Data
(60) Provisional application No. 62/188,290, filed on Jul. 2, 2015.

(51) Int. Cl. G06Q 20/38; G06Q 20/20; G06Q 20/40

(52) U.S. Cl. CPC G06Q 20/385; G06Q 20/405; G06Q 20/206

(57) ABSTRACT

An alternate payment method and system which uses personalized Temporary Assigned Information (tagged to Payment Permanent Detail) as payment information. This personalized Temporary Assigned Information is easily memorable by consumer but hard to guess by others and can be carried in consumer's memory for making payment. This alternative payment method and system decreases the exposure of payment permanent detail during its use and minimize dependency on carrying tangible payment means for in store transactions. Its different features make use of payment process more meaningful, helpful and secure, ease of use and reliable, easy transfer, reporting and monitoring of money.

### CROSS-REFERENCE TO RELATED APPLICATIONS

This application references disclosure and claims the benefit of U.S. Provisional Application having Application No. as 62/188,290 and filing date as Jul. 2, 2015.

### BACKGROUND OF THE INVENTION

Field of the Invention

The present invention relates to alternate payment method and system in payment industry.

Brief Description of the Related Art

Most payment methods which use payment means such as cash, credit cards, debit cards, gift cards, checks, gift certificates, smart phones storing and using directly or indirectly these payment details involve consumer to present these physical means at point of sale(POS) at merchant location. Consumer is required to carry these physical payment means to POS device/Merchant to make the payment. There is possibility of robbery, skimming, theft or handling related problem of these means due to its tangible nature or the way it is used at POS. Cash payment tracking is also difficult for consumer or by IRS/government agency for different audit purposes.

In Online (e-Commerce), Mail Order or Telephone Order Payments, payment detail mostly used is permanent in nature and exposure of such used payment information to unauthorized user leads possible misuse of the information. Also in most of online, Mail Order or Telephone Order (MOTO) purchases or any bill payments, consumer needs to provide or use his/her payment or account detail on merchant's application/or to merchant's associate at time of ordering goods or services or making the bill payments. During this process there may be some possibilities of exposure/interception of the consumer's payment/account detail if merchant's application is not properly built and or does not meet all software and Payment Card Industry Data Security Standard (PCI DSS) or if merchant's associate over the phone or handling the payment information is not reliable or not taking adequate precaution while taking the payment detail from consumer over the phone. Even when consumer provides his/her payment detail over phone then there is possibility of eavesdropping.

If merchant is movable in nature then while taking products or services from such merchants, consumer sometimes finds difficulty in validating identity of most of the merchants before taking products or services or for future reference when required.

### BRIEF SUMMARY OF THE INVENTION

The present invention relates to alternate payment method and system for consumer to use personally assigned temporary information tagged with Permanent Payment Detail and/or in conjunction with consumer's permanent or temporarily detail. Consumer can carry this personally assigned temporary information in his/her memory and provide to merchant as a payment method. This invention also contains method of making payment to merchants for their product or services (not paid in person) based on order or billing information received by consumer from his/her own account of the Payment Solution Provider (PSP) system.

This invention relates to web or app based Point of Sale (POS) for merchant to accept personally assigned temporary information (tagged with Payment Permanent Detail) as alternate payment method securely and reliably on top of accepting Payment Permanent Detail as and when required for in person transaction. This invention also allows merchants to handle, tracking and reporting cash transactions more efficiently and ability of providing promotional offers to consumer with help of currently explained Payment Solution Provider (PSP) of this invention.

### BRIEF DESCRIPTION OF THE DRAWINGS

FIG. 1 contains sample Payment Permanent Detail and its tagged different pieces of information to explain the current invention.

FIG. 2 describes different types of leading number of Temporary Assigned Information tagged to any Payment Permanent Detail.

FIG. 3 describes different ways in which Payment detail can be used.

FIG. 4 describes different security levels which can be assigned to Payment detail either individually or combined with others.

FIG. 5 describes different types of life set for Temporarily Assigned Information tagged to any Payment Permanent Detail.

FIG. 6 describes registration process for consumer and merchant with Payment Solution Provider (PSP).

FIG. 7 describes different processes to manage payment information by consumer based on consumer's need.

FIG. 8 describes processes to accept payment detail by merchant from consumer.

FIG. 9 is a representation of money flow and interactions between different entities which are involved in describing the current invention.

FIG. 10 describes flow chart of different processes when a purchase is done by consumer from any merchant using current invention.

FIG. 11 contains Acronyms, definition of different entities and terms used to explain current invention.

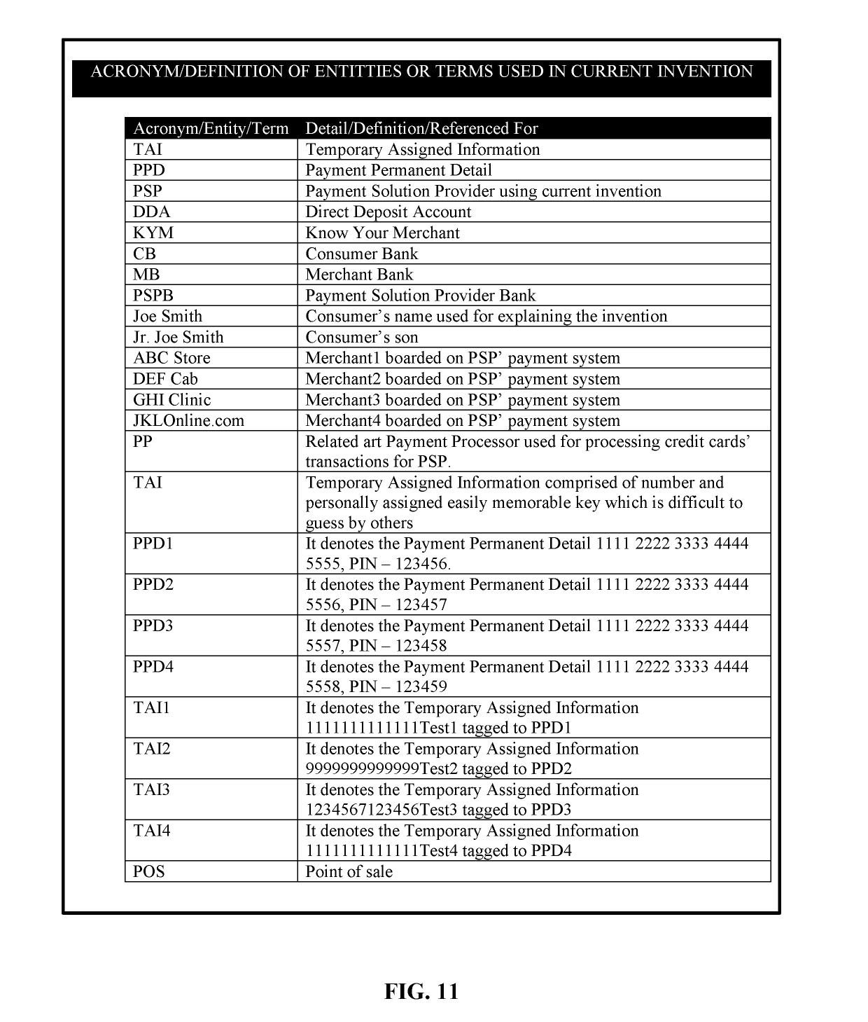

### DETAILED DESCRIPTION OF THE INVENTION

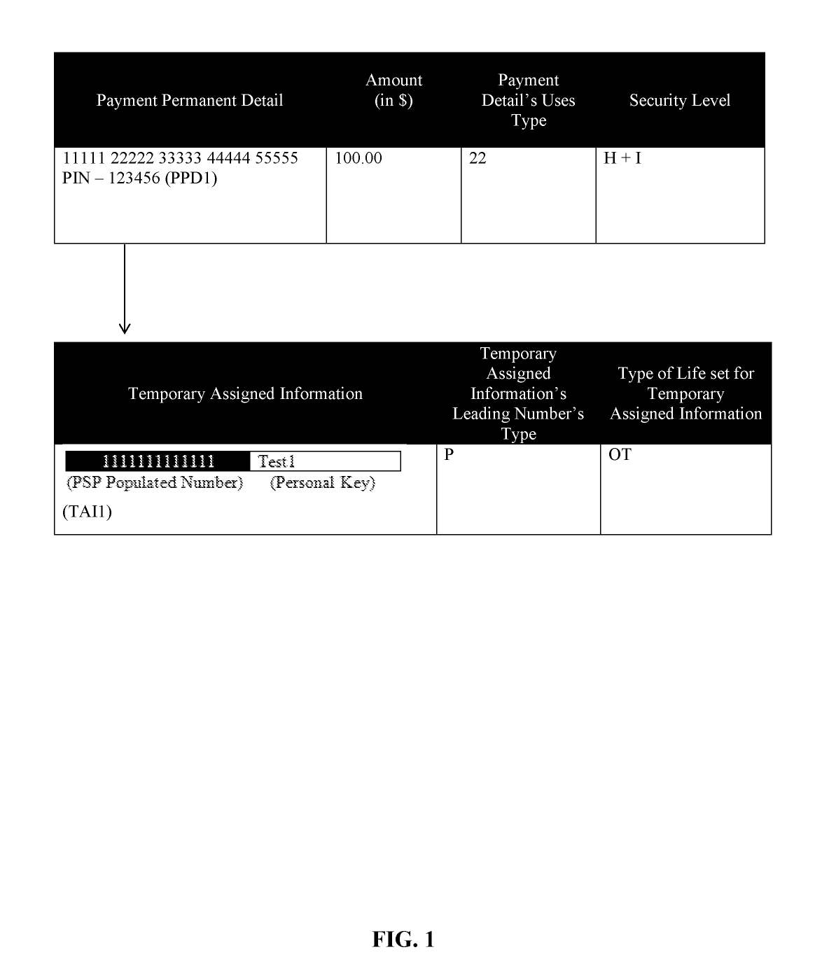

FIG. 1 contains sample Payment Permanent Detail (PPD) ‘1111 2222 3333 4444 5555’ and its PIN as ‘123456’ in Payment Permanent Detail column. For illustration purpose, it is denoted by term ‘PPD1’. Amount column includes $100.00 monetary value associated with ‘PPD1’. Payment Detail's Uses Type column contains sample use type ‘22’ of ‘PPD1’ which means only Temporary Assigned Information (TAI) tagged with ‘PPD1’ can be used as payment primary information at time of payment. Security Level ‘H’+‘I’ mean ‘High’ security level has been assigned to ‘PPD1’ in conjunction with security level ‘Image’.

Sample Personally Temporary Assigned Information (TAI) ‘1111111111111Test1’ is the information which has been assigned by Consumer to PPD1 to uniquely identify it. For illustration purpose, it is denoted by term ‘TAI1’. For illustration purpose, Joe Smith has been considered as Consumer who is owner of all sample PPDs considered for explaining the current invention and Jr Joe Smith has been considered as his son for providing authority of his payment detail use when required. Temporary Assigned Information's Leading Number's Type columns contain ‘P’ which means that ‘TAI1’ leading number is Joe Smith's profile phone number (E.g. ‘1111111111111’). TAI1's second part is Personal Key (E.g. ‘Test1’) which has been appended to phone number by Joe Smith to uniquely identify PPD1 is his account. Personal Key is personally assigned alphanumeric word by consumer which he/she can easily recall at time of payment and other person cannot easily guess it. Type of Life set for Temporary Assigned Information TAI1 is ‘OT’ which means ‘TAI1’ can be used only one time by Joe Smith. ‘TAI1’ cannot be reused until Joe Smith reassigns it to any available PPD in his account.

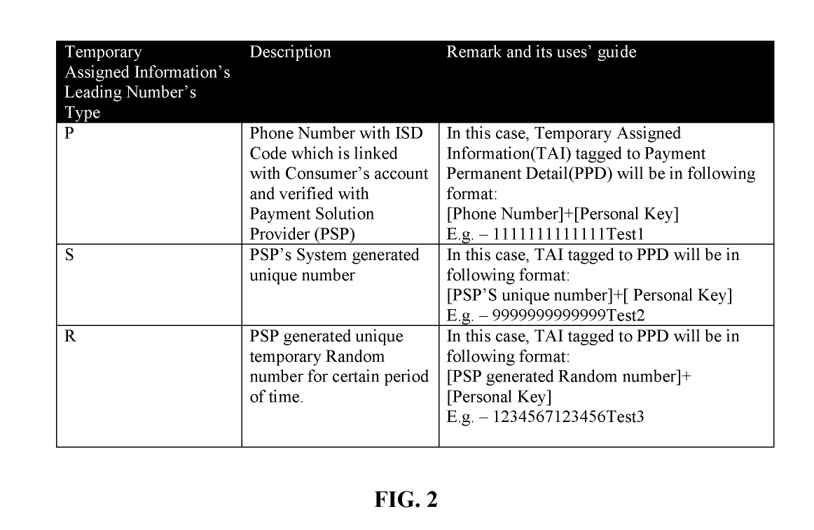

FIG. 2 describes different Temporary Assigned Information's Leading Number's Types. ‘P’ stands for Phone. Consumer's own phone number is easily memorable unique number present in Payment Solution Provider (PSP)'s system and Consumer can use it to make his/her personalized TAI.

‘S’ stands for Payment Solution Provider (PSP)'s System generated unique number. If Consumer does not want to use his/her profile phone number for any reason then PSP can provide its system generated unique number which will be used to create personalized TAI. Consumer can request for change of this number when required and get it replaced with other unique number. Consumer will have to remember this number for its created TAI use. E.g. 9999999999999Test2 is created as TAI for another PPD2 present in Joe Smith Account where 9999999999999 is PSP's System generated unique number assigned to Joe Smith for permanent use until he requests for its replacement with other permanent unique number. For reference purpose this TAI ‘9999999999999Test2’ is termed as TAI2.

‘R’ stands for PSP's System generated unique temporary Random number for certain period of time. This random number should be used to form TAI where Consumer does not want to use TAI formed with leading number's type P or S. E.g. ‘1234567123456Test3’ has been created by Joe Smith as TAI tagged with other PPD3 present in his account where ‘1234567123456’ is PSP's System generated unique temporary Random number. For reference purpose, this TAI is termed as ‘TAI3’.

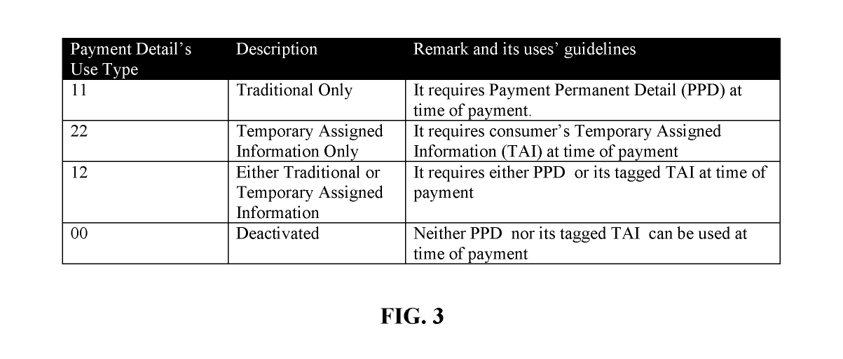

FIG. 3 describes different ways in which payment detail can be used. ‘11’ stands for ‘Traditional Only’ which requires consumer to enter PPD at time of payment. In current invention, this method is not preferred way to make any payment. It is default payment method assigned by PSP with a PPD for use.

‘22’ stands for ‘Temporarily Assigned Information Only’. When this Payment Detail's Use type is assigned to any PPD then only its tagged TAI can be used at time of payment. In current invention, it is preferred way of using payment detail.

‘12’ stands for ‘Either Traditional or Temporarily Assigned Information’. When this Payment Detail's Use type is assigned to any PPD then either PPD or its tagged TAI can be used for payment.

‘00’ stands for ‘Deactivated’. When this Payment Detail's Use Type is assigned to any PPD then neither PPD nor its tagged TAI can be used for payment. This is recommended to be set for any PPD which is not supposed to be used by consumer in coming days/weeks or if consumer thinks that any PPD or PPD tagged TAI has been compromised during its use.

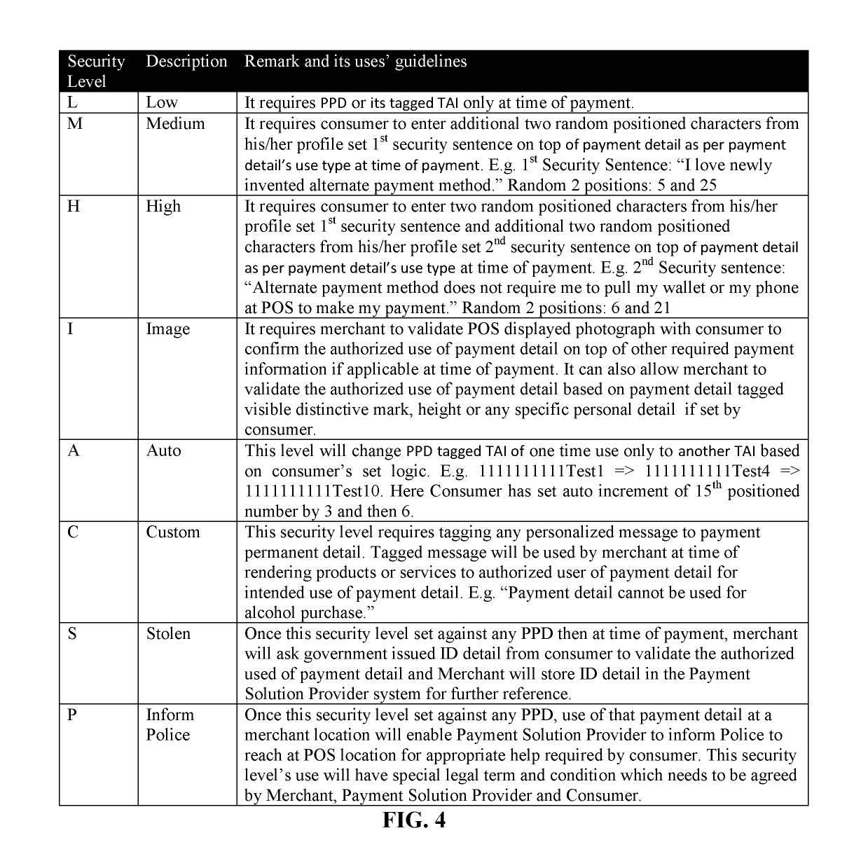

FIG. 4 describes different types of security levels proposed as part of current invention. ‘L’ stands for ‘Low’. It requires PPD or its tagged TAI only at time of payment. It can be combined with other security level as and when required. ‘M’ stands for ‘Medium’. It requires consumer to enter additional two random positioned characters from his/her profile set 1^{st} security sentence on top of payment detail as per PPD's use type. E.g. “I love newly invented alternate payment method.” has been set as 1^{st} security sentence in Joe Smith's profile and if at time of payment, PSP's system generated random 2 positions are 5 and 25 then Joe Smith needs to enter ‘v’ and ‘t’ respectively to process the payment.

‘H’ stands for ‘High’. It requires consumer to enter two random positioned characters from his/her profile set 1^{st} security sentence and additional two random positioned characters from his/her profile set 2^{nd} security sentence on top of payment detail as per PPD's use type at time of payment. E.g. If Joe Smith's 2^{nd} Security sentence is “Alternate payment method does not require me to pull my wallet or my phone at POS to make my payment.” And Random 2 positions from 2^{nd} security sentence are 6 and 21 then Joe Smith needs to enter ‘v’, ‘t’, ‘m’ and ‘t’ respectively to process the payment. Security Level L, M and H are mutually exclusive and hence cannot be used with one another.

‘I’ stands for ‘Image’. For applying this security level to any PPD, consumer needs to tag authorized user's photograph to that PPD. By default PSP uses consumer's photograph which has been approved by PSP based on consumer's provided government issued ID during his/her registration with PSP. Consumer can tag his/her relative photograph with any PPD if he wants his relative to use his payment information when required. This security feature also allows consumer to tag PPD associated user's easily visible distinctive mark (if any), height or user appearance related specific detail. This security level can be used with any other security level.

Based on uses pattern of payment detail, PSP can also auto apply any of security levels explained above based on information present in consumer's account.

‘A’ stands for “Auto”. This level will change PPD tagged TAI of one time use only to another TAI based on consumer's set logic. E.g. 1111111111Test1=>1111111111Test4 =>1111111111Test10. Here Consumer has set auto increment of 15^{th} positioned number by 3 and then 6. This is recommended for use at place where Merchant has not a secure environment to enter TAI. This security level can also be used with any other security level.

‘C’ stands for “Custom”. This security level requires consumer to tag any personalized message to payment permanent detail. Tagged message will be displayed on POS at time of payment and can be used by merchant at time of rendering its products or services to authorized user to control the purchase done with provided payment detail. E.g. Personalized Message “Payment Detail cannot be used for alcohol purchase.” When tagged to ‘PPD2’ by Joe Smith and ‘TAI2’ is given as gift to Jr. Joe Smith who is 21 year old son of Joe Smith. When Jr. Joe Smith goes to any retail store and purchases some games CDs and alcohol. At time of checkout, cashier of that retail store sees the message at time of processing the payment and does not allow alcohol to be purchased although he is more than 18 year old.

‘S’ stands for ‘Stolen’. This security level's tagging to any PPD can be used by consumer when consumer perceives that its PPD or TAI has been compromised by other person during its use at any merchant's location. When compromised payment detail will be used by any person then Merchant will ask government issued ID to be stored in PSP system. In this particular situation, Merchant may or may not accept rendered payment detail. This stored ID detail can be accessed by Merchant, authorized user of used payment detail, police or government body in future as and when required. If Authorized user of payment detail under discussion does not recognize the stored ID of that person then he/she can dispute the transaction and further investigation will be done. Stored ID will also be entered in PSP's negative database for further reference. If Authorized user finds that user of payment detail in question is his/her own authorized relative and he/she has set it by mistake then he/she can simply void that ID to be removed from the system. ‘P’ stands for “Inform Police”. This security level has been invented for getting police assistance at point of sale (POS). Consumer is advised to assign this security level to one of its PPD and give its tagged TAI to each of his/her family member to use in case of emergency.

When such TAI will be used at POS then PSP will inform police to go to merchant location where TAI was used. Use of this feature will have its own special terms and conditions which need to be accepted and followed by TAI user, Consumer assigning this security level, merchant and PSP.

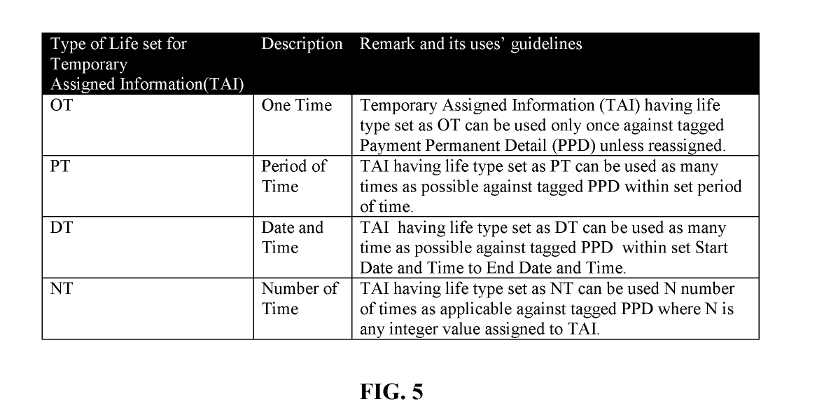

FIG. 5 describes types of life set for Temporary Assigned Information (TAI). ‘OT’ stands for ‘One Time’. TAI having life type set as ‘OT’ can be used only once against tagged PPD. Once that TAI is used for payment, it cannot be reused without reassigning it to any payment permanent detail available for consumer.

‘PT’ stands for ‘Period of Time’. Temporary Assigned Information (TAI) having life type set as ‘PT’ can be used as many times as possible against tagged Payment Permanent Detail (PPD) within set period of time. Period start time will be the point of time when period of time is assigned and period end time will be start time+assigned period of time. E.g. If consumer is setting PT as 2 hours at 2:00 PM CST on Jun. 30, 2015 then TAI can be used any number of times between 2:00 PM CST to 4:00 PM CST on Jun. 30, 2015.

‘DT’ stands for ‘Date and Time’. Temporary Assigned Information (TAI) having life type set as DT can be used as many time as possible against tagged PPD within set Start Date and Time to End Date and Time. E.g. If Joe Smith gives ‘TAI2’ as a gift to Jr. Joe Smith to use on his 22th B'day which is on Jun. 30, 2016 with use start date and time as Jun. 30, 2016 12:00 AM CST and end date and time as Jul. 5, 2016 11:59 PM CST then he will be able to use TAI2 only between above specified point of time.

‘NT’ stands for ‘Number of Time’. Temporary Assigned Information (TAI) having life type set as NT can be used N (value set at time of setting NT life type) number of times as applicable against tagged PPD where N is any integer value assigned to TAI. E.g. If TAI2 life type is set as 10 then it can be used up to 10 times against tagged PPD2.

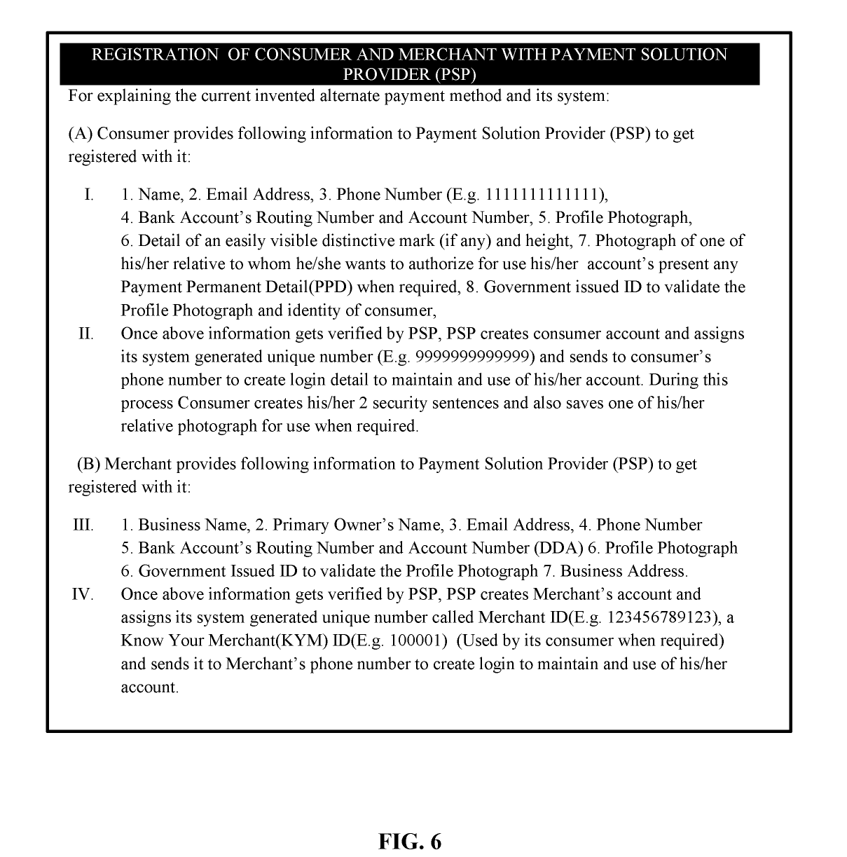

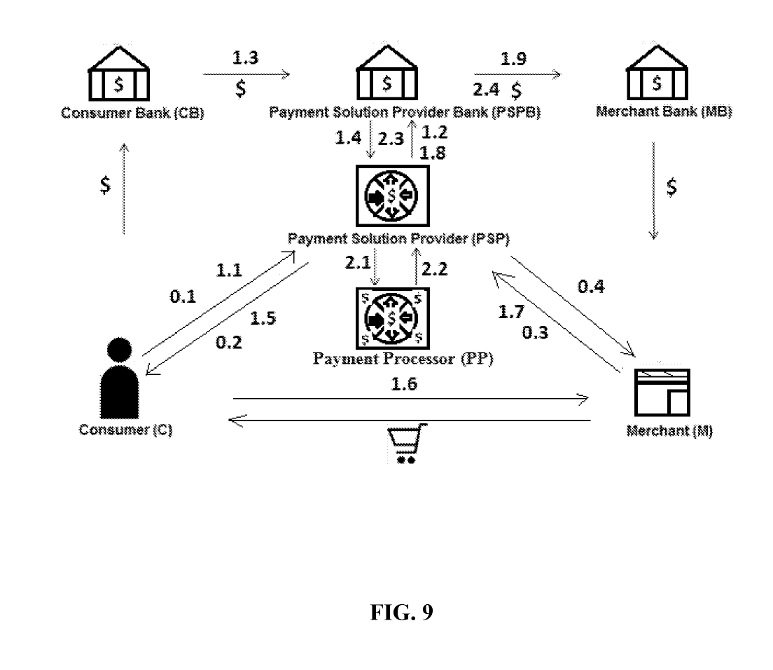

FIG. 6 describes information collected from consumer and merchant by PSP to explain use of alternate payment method and system of current invention. In FIG. 9, this process has been denoted by 0.1, 0.2, 0.3 and 0.4 corresponding to FIG. 6 mentioned number I, II, III and IV respectively. For Illustration of current invention, Jr. Joe Smith's photograph has also been collected for demonstrating sharing of payment detail by Joe Smith when required. ABC Store has been considered as Merchant using PSP's payment system to accept payment.

FIG. 9 listed PSP which has been mentioned in above sections is Payment Solution Provider (PSP) using current invention.

PP is related art Payment Processor who will act like payment processor in current invention for PSP to explain credit card transaction done by Joe Smith who has also stored his credit card in his PSP Account's wallet.

FIG. 9 mentioned number 1.1 shows Joe Smith's request for money transfer from his bank account to PSP of $100.00. 1.2 shows request submitted by PSP to his bank PSPB. 1.3 shows money transfer from Consumer Bank (CB) to PSPB. 1.4 confirms the money transfer to PSP. 1.5 shows PPD1 allocated to Joe Smith. Joe can also get money added to his PSP account by other means like credit cards, issuing check or giving cash to PSP, requesting money from his friend who is also having PSP account, doing bill payment to PSP account etc. For different functionalities illustration, PPD2 of $20.00 and PPD3 of $0.00 have also been added in his account.

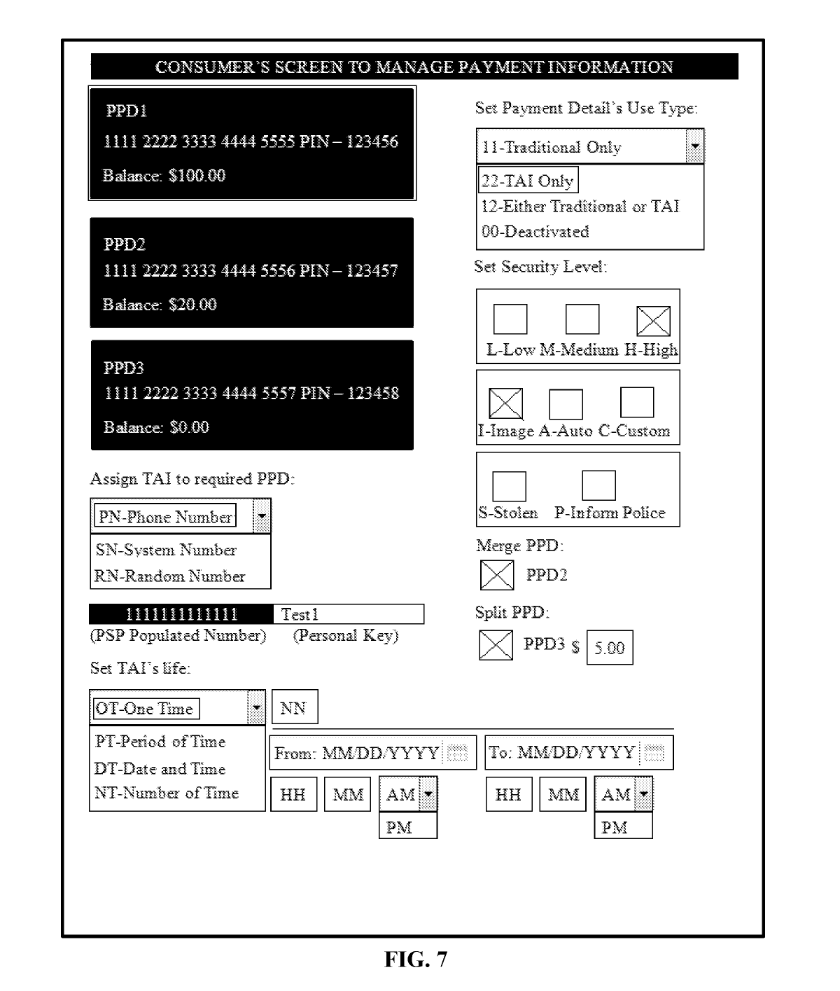

FIG. 7 describes process to manage consumer's payment detail. For assigning TAI to PPD1, Joe Smith selects PPD1. After that he selects TAI's leading number type from the dropdown as PN. It enables system to prepopulate PSP verified his phone number (1111111111111) as first part of TAI. He enters ‘Test1’ as his Personal Key. So ‘TAI1’ becomes ‘1111111111111Test1’. Then he selects TAI life type as OT-One Time. It will not require entering any extra information for its life as it is just for one time use. Then he assigns 22-TAI Only as Payment Detail's Use Type. It means he can only use TAI1 to use PPD1. Then he selects Security Level as H-High along with another Security Level as I-Image. It will require Joe Smith to enter ‘TAI1’ along with 4 random positioned characters at time of payment and will require merchant to verify POS screen displayed photograph with Joe Smith.

FIG. 7 also explains merging and splitting functionality of PPDs present in consumer's account. E.g. If Joe Smith wants to merge PPD2's $20.00 to PPD1 then he needs to select PPD1 and then under ‘Merge PPD’ section he needs to select PPD2. It will transfer $20.00 to PPD1 to make its available balance as $120.00. For splitting money from PPD1 to PPD3, he needs to select PPD3 present under ‘Split PPD’ section and enter required amount say $5.00. Then it will transfer $5.00 from PPD1 to PPD3 to make PPD3's value from 0 to $5.00 and decrease the value of PPD1 by $5.00. Suppose Joe Smith plans to go to his friend's B′day party and he needs to give $5.00 as gift. He uses TAI3, sets its security level ‘L’ and life of TAI3 as required and gives to his friend. His friend can directly use it in PSP serviced merchant location or can add it to his/her PSP account for future use. At time of addition to friend's PSP account, Joe Smith will also receive message from his friend to accept the required addition in his PSP account. Once accepted by Joe Smith, new PPD will be assigned to Joe's friend account which can be managed by him and used as and when required. In both cases PPD3 balance will become $0.00.

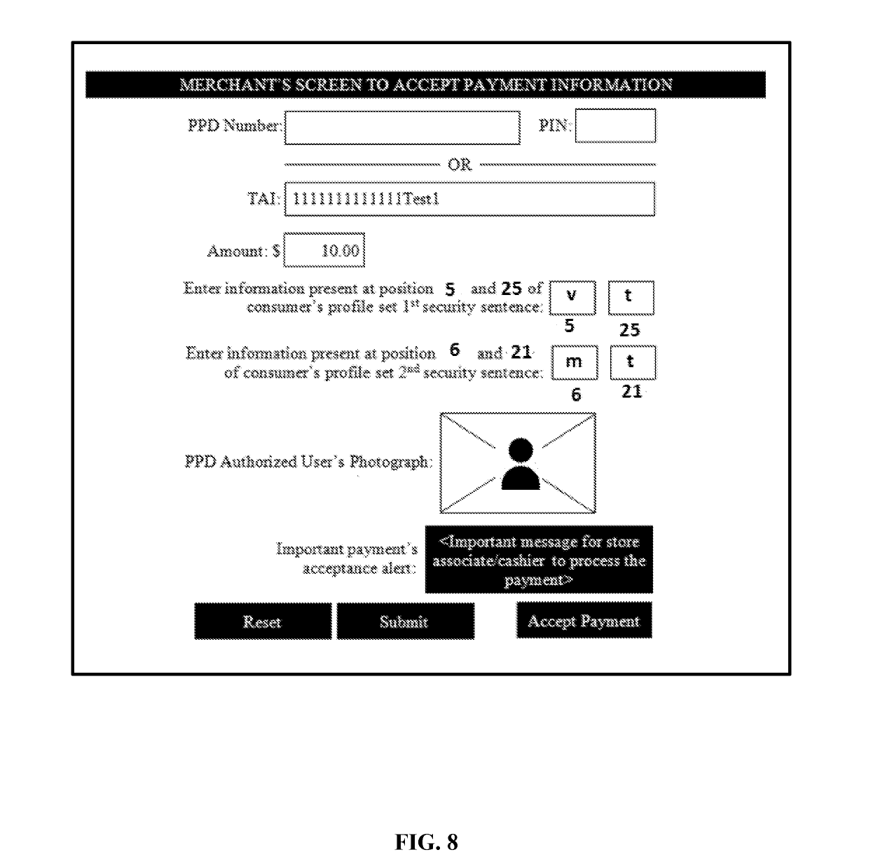

FIG. 8 describes process to accept a payment by merchant at merchant location. E.g. Joe Smith buys $10 worth grocery from ABC Store. At checkout counter, he enters ‘TAI1’ information first to process the payment. For safety of TAI1 entry, in this example, ABC Store has placed covered keypad so that while accepting ‘TAI1’ from Joe Smith, nobody (including ABC store's cashier) can see the entered information. POS Screen will simply display multiple *'s in TAI field. In FIG. 8, clear text of TAI1 or other Joe smith's entered information has been displayed for illustration purpose only. Store Associate submits the Payment detail. In response he gets ‘TAI1’ tagged photograph along with important payment's acceptance alert message as follow: “After Image verification, ask Consumer to enter 5^{th} and 25^{th} character from his 1^{st} Security Sentence and 6^{th} and 21^{st} character from 2^{nd} security sentence” based on TAI1 setting done by Joe Smith at time of its creation. If Image does not match with Joe Smith, Store Associate can simply deny the payment. In case of image matched, Joe Smith is asked to enter 4 characters. He enters v, t, m and t in sequence in covered keypad. Store associate again submit the Payment Information and receives Payment Successful as important payment's acceptance alert message. This completes the transaction. In case of ‘TAI1’ Security level L+I, Store associate can simply click “Accept Payment” after matching the photograph. This exchange of information has been denoted as number 1.6 and 1.7 in FIG. 9. Joe Smith takes grocery from ABC Store which completes the purchase. PSP sends the required amount of money transfer request (shown as 1.8) to PSPB for ABC store after deducting the processing cost. PSPB transfer the requested amount to ABC Store's bank account present in Merchant Bank (MB) shown as 1.9.

In case of Credit Card transaction by Joe Smith by using its tagged TAI, after final submission of payment information to PSP by ABC store, PSP sends Authorization Request to its Payment Processor (PP) (shown as 2.1 in FIG. 9). Based on response received from its PP, it displays the Payment successful or decline message to ABC store POS screen for processing the payment. During settlement, PSP receives money from its PP and then sends required amount money transfer request to PSPB for ABC Store's bank account (shown as 2.2, 2.3 and 2.4 in FIG. 9). Joe pays his credit card bill as usual.

This section of current invention describes ‘Know Your Merchant’ concept for consumer. Joe Smith wants to use his ‘TAI1’ in a Cab (E.g. DEF Cab) to get its service. DEF Cab is a registered merchant of PSP with KYM ID (E.g. 100002) to explain this invention. After registration process, PSP requires DEF Cab to assign unique Sub KYM ID to each of its cab drivers with his recent photograph. Say KYM Sub ID assigned to cab driver as 100002-009. Joe Smith asks KYM ID from cab driver and put it in his mobile PSP's app. Joe Smith, after entering KYM ID of cab driver, gets cab driver's photograph. He verifies it with cab's driver and takes ride for his required destination.

For making alternate payment solution better, secure, reliable and efficient, this section of current invention describes scoring system for PSP. It will be based on how consumers and merchants use their PSP account to manage and conduct payment activities. At time of registration, PSP account holder will be assigned initial PSP score based on account holder's profile detail and education level. If Account holder uses complex account password, changes of his/her password at regular interval, logins into his/her account from his/her personal device from safe place where login detail while entering cannot be easily seen by others, uses not easily predictable Personal Key for TAI, uses required security features of payment detail defined in PSP based on value of PPD and nature of its use, uses less number of time forget password features, keeps strong security sentences, protects its TAI, complies with all payment industry and PSP guidelines etc. then PSP score will be increased by PSP. If payment dispute goes against account holder then it will impact its score negatively. PSP score of account holder can be used by PSP, government or any other agencies as per term and condition signed by account holder at time of registration.

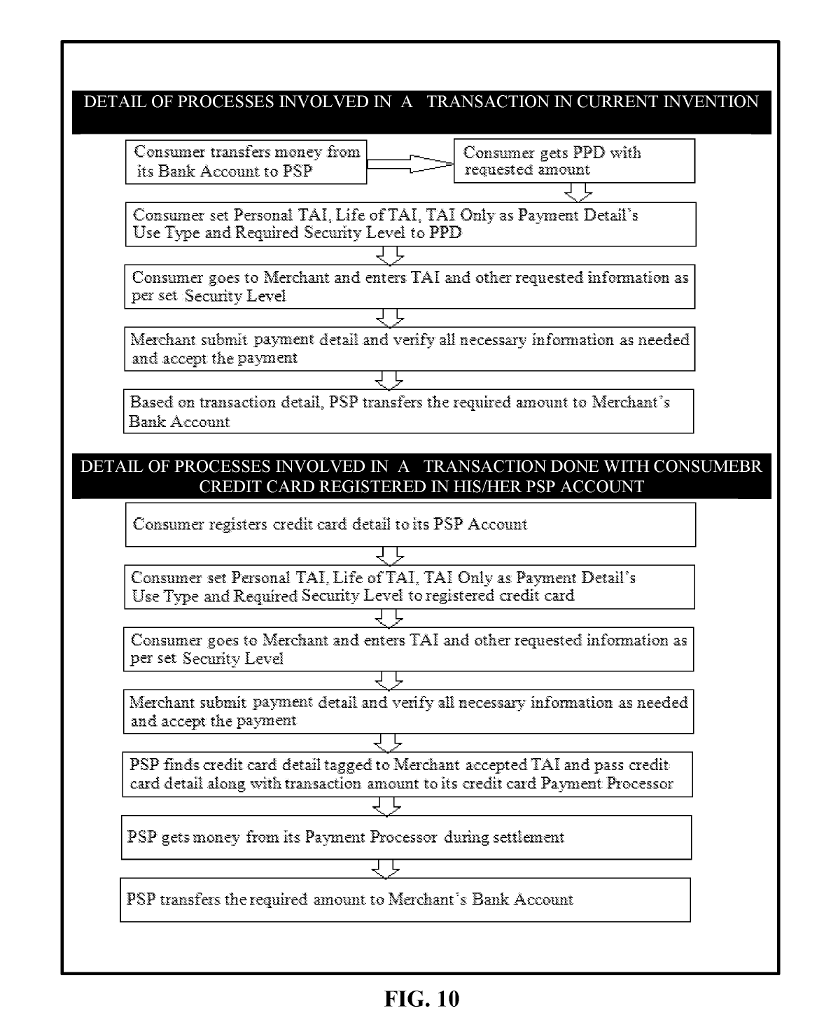

FIG. 10 describes detail of processes involved in a sample transaction of PSP issued PPD and transaction done by consumer with its PSP account's added credit card.

For making cash transactions better for IRS/Government agency tracking and audit purpose and for giving consumers and merchants better cash management, currently invented Payment Solution Provider (PSP) payment system has provision for recording the cash transactions. While making the cash payment, Merchant asks consumer to enter TAI assigned to Payment Permanent Detail created in his/her PSP account to track cash transactions. This enables transaction amount to be recorded in Consumer's Account, Merchant's Account and PSP payment system as cash transaction and can be referenced as and when need for desired purpose. During cash transactions, current invention may allow merchant to return the change (money) in Consumer' account which will eliminate time consuming process involved in returning the change to consumer. It will also give better consumer experience by not carrying changes (different coins) after cash payment. IRS/Government entity can request detail of cash transactions for a merchant from its PSP. Any cash transaction has been recorded by merchant or not can be easily audited with help of its PSP. E.g. Joe Smith creates Payment Permanent Detail (PPD4) as 1111 2222 3333 4444 5558 and PIN as 123459 and assigns his personal Temporary Assigned Information as 1111111111111Test4. He updates his current cash availability (say $100) to PPD4. He sets TAI's security level as L and its use type as 22 for 1 month. He goes to ABC Store and buys grocery worth $99.25. He provides $100 bill to ABC Store and enters his TAI4 for cash transaction record in his PSP Account and get the change back to it. During completion of cash transaction, ABC Store's associate click option for returning change to Consumer's account. It completes the cash transaction. After this transaction, when Joe Smith logs into his PSP account, he sees balance of PPD4 as $0 and his PSP Account balance increases by $0.75. During settlement process of PSP with ABC Store, PSP deducts $0.75 from ABC Store's total deposit amount for the day due to all type of transactions made with PSP payment system and deposits the difference to ABC Store's bank account with MB. This whole process records the $99.25 as cash transaction in Joe Smith's PSP Account, ABC Store's PSP account and PSP payment system for future reference and eliminates the need to return $0.75 as coins to Joe Smith by ABC Store and eliminates the need of carrying the same by Joe Smith. PSP Payment system can report this transaction to IRS/Government agency as and when required.

This section of current invention describes ability of a consumer to let his/her financially trusted friends know cash availability with him/her and manage the transfer with help of his/her PSP's account so that when his/her friends need cash, he/she can borrow or lend them for occasional use and record it if needed. E.g. Joe Smith added his friend A, B and C as his financially trusted friends who lives nearby or works at same office. His Friend A has $30 cash with him, friend B has $50 of cash with him and his friend C has $100 of cash with him. All these friends have updated this information in their respective PSP's account so that their financially trusted friends can see it and contact them when they need. Now Joe Smith needs $175 cash for emergency use. Instead of going to ATM or using other means currently available in market, he can log into his PSP's account and browse cash availability within his trusted friends A, B and C and avail the required cash. Similarly he can add his own cash availability to his account to be browsed by his friends so that they can take advantage of his cash availability when they need. In prior art, if Joe needs cash from his friends then he needs to inquire cash availability from his circle of financially trusted friends which takes more time and cause inconvenience.

This section of current invention describes ability to provide additional cashbacks to consumer by a merchant with help of PSP payment system for sales promotion purpose on top of what cashback is offered to consumer by payment card issuer. These merchant's additional cashbacks' offer detail can be seen by consumer when he/she browses the merchant in his PSP Account/in PSP Application/in merchant web site/in Merchant's store as advertised. One type of such additional cash back given to consumer can be used to put it in his PSP's Account balance while other can only be used with that specific merchant during next or future visit as and when needed. Consumer can also convert later type of cash back into that merchant's gift card and can give to his/her friend when required. To enable this feature for merchants, PSP provide separate cash back fees to be added in Merchant's accounts whose value can be set and controlled by merchant as and when needed. E.g. PSP during merchant boarding process or later upon merchant ABC Store's request adds two additional cashback fees for its sales promotion say ACBF1—0.5% per transaction and ACBF2—$5 one time its store specific offer given to its consumers by ABC Store. ABC Store activates these two cashbacks for a certain period of time. When Joe Smith visits the merchant during that period of promotion and makes a transaction of $100. PSP during transaction settlement process after deduction of its processing fee say $2, it further deducts $0.5 as additional cashback 1 and $5 as additional cashback 2 and put $92.5 in merchant account. PSP transfers $0.5 to Joe Smith PSP account and $5 as separate balance to his account to be used for ABC Store.

This section of current invention describes ability of a consumer to make payment directly from his/her Payment Solution Provider's (PSP) account by providing required detail of ordered/received products/services or bill statement received for which payment was not done in person or with merchant's owned application at time of ordering or taking products/services. In this invention, PSP builds a user's interface accessible from Consumer's own PSP's account which has provision to search the PSP boarded merchants by its business name or directly by entering its detail (Merchant ID/KYM ID) from which he/she has ordered or taken products/services. After merchant's detail is displayed with additional detail to be entered for making the payment, consumer enters order detail/statement bill details, makes the payment and receives payment confirmation. PSP update the payment status to merchant system against the order or consumer's account as applicable. E.g. Joe Smith has visited GHI Clinic for his health checkup. After one month he receives paper bill statement to pay his clinic office visit bill. He goes into his PSP's account and searches GHI Clinic and enters his account number/financial number present on the bill statement and click enter. He sees the amount against that bill and due date to pay the bill. He selects his required payment detail from his account and makes the payment. PSP confirms the payment status to Joe Smith and updates GHI Clinic application for payment. In another example, Joe Smith visits JKLOnline.com and selects products he wants to buy from it. During checkout he selects the payment method as “Pay from PSP Account Offline” and places the order. He receives order number from order confirmation page or an email received after order placing. He logs into his PSP account, enters JKLOnline.com detail and order number and makes the order's total payment. PSP update the order status to JKLOnline.com system so that JKLOnline.com can ship the purchased products. In this process current invention helps Joe Smith to avoid use of his payment detail on JKLOnline.com or payment account detail entry on PSP interface either embedded on JKLOnline.com or directed on it from JKLOnline.com at time of order placement.

What is claimed is:

1. A payment system which allows an alternate payment method containing replacement of Payment Permanent Detail (PPD) with personalized Temporary Assigned Information (TAI) which is easily memorable by consumer but difficult to guess by other unauthorized user and can be carried in consumer's memory to make the payment.

2. The payment system of claim 1, wherein the payment system further comprises act of allowing consumer's authentication and authorization in face to face payments based on security settings such as use of random positioned characters from Payment Permanent Detail (PPD) associated security sentences, auto change of PPD tagged personalized Temporary Assigned Information (TAI) in predefined logic set by consumer after the TAI use, validation of authorized use of payment based on comparison of Point of Sale (POS) displayed consumer's image, height, visible mark or consumer's appearance related specific detail set by consumer for payment in use with corresponding detail of consumer using the payment , authorization of buying any product or services by a merchant based on custom message displayed on POS for payment used, collection of payment user's government ID by merchant based on payment's security setting and automated call to Police by Payment Solution Provider (PSP) once consumer's set specific payment is used at POS by the consumer.

3. The payment system of claim 1, wherein the payment system further comprises the act of allowing flexibility to use Payment Permanent Detail (PPD) or its tagged personalized Temporary Assigned Information (TAI) and restricts any one or both of them by payment account holder or by Payment Solution Provider as and when needed.

4. The payment system of claim 1, wherein the payment system further comprises the act of allowing use of Temporary Assigned Information (TAI) tagged to Payment Permanent Detail (PPD) based on its life such as one time, between certain date range and time or multiple times to fulfill exact need of consumer.

5. The payment system of claim 1, wherein the payment system comprises the act of allowing a digital wallet concept which stores the prior art payment card detail and allow its use by the alternate payment method of claim 1 in conjunction with different security settings as explained in claim 2, flexibility or restriction as explained in claim 3 and its life as explained in claim 4.

6. The payment system of claim 1, wherein the payment system comprises the act of allowing creating, merging or splitting of Payment Permanent Detail (PPD) by consumer based on consumer's need and facilitate its use by the alternate payment method of claim 1 in conjunction with different security settings as explained in claim 2, flexibility or restriction as explained in claim 3 and its life as explained in claim 4.

7. The payment system of claim 1, wherein the payment system comprises the act of allowing Know Your Merchant (KYM) concept to be used by consumer for verifying identity of Merchant as and when required.

8. The payment system of claim 1, wherein the payment system comprises the act defining score for a consumer or merchant on use and management of the alternate payment method of claim 1 over period of time.

9. The payment system of claim 1, wherein the payment system comprises the act of cash transactions processing, recording, tracking and reporting by consumers, merchants, and Payment Solution Provider (PSP) payment system coupled with better consumer's experience of allowing them to see all their cash transactions in their PSP account and if required getting change money back to their PSP account from merchant to avoid carrying changes which may include different coins on top of paper bills, better merchant's experience of rendering changes to consumers into their PSP account directly after cash transactions and ability of PSP payment system to report cash transactions detail to IRS/government agency as and when required.

10. The payment system of claim 1, wherein the payment system comprises the act of allowing consumers to share or know their cash availability with their friends so that consumers can lend/borrow required amount of cash without prior inquiring over the phone or asking directly whether their friends have cash or not when needed occasionally.

11. The payment system of claim 1, wherein the payment system comprises the act of allowing merchants to offer and control cashbacks to its consumers on top of what is offered to the consumers by its payment card issuer to promote its sales.

12. The payment system of claim 1, wherein the payment system comprises the act of allowing consumers to make the payment from their Payment Solution Provider's (PSP) account for products or services ordered/received from online/Mail Order/Telephone Order or bill statement received for any already taken products or services to avoid directly providing their payment detail to Merchant's application or its associate over the Telephone which sometime results possible payment information compromise or interception.
